(19) United States
(12) Patent Application Publication
(10) Pub. No.: US 2001/0055131 A1
(43) Pub. Date: Dec. 27, 2001

(54) Optical element and apparatus

(76) Inventor: Hiroshi Suganuma, Ibaraki (JP)

Correspondence Address: SONNENSCHEIN NATH & ROSENTHAL, P.O. BOX 061080, WACKER DRIVE STATION, CHICAGO, IL, 60606-1080, US

(21) Appl. No.: 09/822,555

(22) Filed: Mar. 30, 2001

(30) Foreign Application Priority Data
Mar. 31, 2000 (JP) P2000-101353

(51) Int. Cl. G03H 1/00

(52) U.S. Cl. 359/1

(57) ABSTRACT

An optical element comprises a volume hologram, converts an aspect ratio of an incident beam, and emits it as an outgoing beam.

### RELATED APPLICATION DATA

The present application claims priority to Japanese Application No. P2000-101242 filed Mar. 31, 2000, which application is incorporated herein by reference to the extent permitted by law.

### BACKGROUND OF THE INVENTION

The present invention relates to an optical element and an optical apparatus using the optical element. More specifically, the present invention relates to an optical element and an optical apparatus using the optical element which irradiates an incident beam by converting its aspect ratio.

Conventionally, there have been used a liquid crystal display (LCD) panel, a digital micro-mirror device, and the like as a projection display. Recently, there has been developed a grating light valve (hereafter referred to as the GLV), namely a display using active drive grating based on the micro-machining technology. Particular attention is paid to it. As described in U.S. Pat. No. 5,311,360, May 10, 1994, Method and Apparatus for Modulating a Light Beam, Stanford, the GLV features excellent capabilities of, say, seamlessly displaying clear and bright images, reducing manufacturing costs by using the micro-machining technology, and providing high-speed operations compared to a conventional spatial light modulator.

A typical GLV forms one pixel using six ribbons each of which is 6_m wide. Accordingly, a width of approximately 37 mm is required for representing 1,024 pixels. Each ribbon is approximately 100 μm long, providing a vertical-to-horizontal aspect ratio of approximately 370:1. Therefore, a beam with a high aspect ratio is needed for effectively illuminating this pixel region. To generate such a beam with a high aspect ratio, for example, a cylindrical lens is used to condense the beam in a one-dimensional direction. In this case, the reflected light returns to the cylindrical lens since the GLV is a reflective spatial modulator. When an optical system projects the reflected light from the GLV on a screen using this cylindrical lens, it is necessary to correct a skew beam aberration caused by the cylindrical lens. There may be the case where an optical axis of the cylindrical lens is tilted for letting the light slantingly enter the GLV and forming an image in an image formation system. In this case, an object slants against the optical axis, thus slanting the image. In any case, the optical system requires some resources. Accordingly, the prior art causes a problem of complicating the GLV structure.

A liquid crystal display requires a complicated structure using a color filter, a deflector, and the like, decreasing optical utilization efficiency. There arise problems of dark images and consumption of a large amount of power for a light source. Accordingly, the liquid crystal display needs to improve the optical utilization efficiency.

An acoustooptic polariscope increases the number of decomposition points as an incident beam's aspect ratio increases. Conventionally, the acoustooptic polariscope has been used by placing it between cylindrical lenses, causing a problem of complicating and enlarging the structure. For easy and fast signal processing, a one-dimensional shutter array or a one-dimensional detector array is used for various purposes. However, the use of these arrays often requires a beam shape with a high aspect ratio.

Conventionally, an anamorphic prism has been often used for producing a beam with a high aspect ratio. For example, a semiconductor laser's outgoing beam is usually oval. For improving a condensing characteristic, it is a common practice to approximate the semiconductor laser's beam shape to be round using the anamorphic prism. Generally, an anamorphic prism has several magnifying powers. Presently, commercially available standard anamorphic prisms provide magnifying powers of 2 to 6. For further increasing the magnification, a plurality of anamorphic prisms needs to be used, complicating the optical system.

In recent years, a liquid crystal display's back panel is researched and developed variously. Since a conventional light guide plate is based on reflection, a beam enters the liquid crystal panel slantwise, requiring corrective measures for it.

### BRIEF SUMMARY OF THE, INVENTION

The present invention has been made in consideration of the foregoing. It is therefore an object of the present invention to provide an optical element and an optical apparatus with a simple structure for providing a light beam having a high aspect ratio.

An optical element according to the present invention comprises a volume hologram, converts an aspect ratio of an incident beam, and emits it as an outgoing beam.

The optical element according to the present invention uses the volume hologram. Owing to an excellent diffraction characteristic of the volume hologram, the optical element converts an aspect ratio of an incident beam and emits it as a reproduction beam with an increased aspect ratio. Accordingly, this optical element emits an outgoing beam from the light beam by processing it with the high aspect ratio conversion which is conventionally only available through the use of a complicated optical system or is conventionally unavailable.

An optical apparatus according to the present invention comprises a light source for generating a light beam with a specified aspect ratio, an optical element comprising a volume hologram, and a display screen illuminated by a beam generated from the light source. When an incident beam is generated from the light source and enters the optical element, the optical element converts an incident beam's aspect ratio and emits the beam as a reproduction beam. This reproduction beam with the converted aspect ratio illuminates the display screen.

When the light source generates a light beam with a specified aspect ratio, the optical apparatus according to the present invention uses the optical element to convert that light beam to a light beam with a high aspect ratio. For this purpose, the optical element provides an excellent diffraction characteristic. The optical apparatus extracts a reproduction beam with the high aspect ration and irradiates this reproduction beam onto the display screen. Accordingly, this optical apparatus brightly illuminates the display screen through the use of the optical element which excels in diffraction efficiency.

As mentioned above in detail, the optical element according to the present invention comprises a volume hologram and emits an incident beam as an outgoing beam by converting the incident beam's aspect ratio. The optical element according to the present invention uses the volume hologram. Owing to an excellent diffraction characteristic of the volume hologram, the optical element converts an aspect ratio of an incident beam and emits it as a reproduction beam with an increased aspect ratio.

Accordingly, the optical element according to the present invention can generate a light beam with the high aspect ratio conversion which is conventionally only available through the use of a complicated optical system or is conventionally unavailable. When the optical element according to the present invention is used for an optical apparatus and the like, the number of apparatus parts can be decreased owing to its excellent diffraction efficiency. The optical apparatus configuration can be simple and compact.

The optical element according to the present invention uses the optical element comprising the volume hologram. According to an excellent diffraction characteristic of the optical element, the optical apparatus converts a given aspect ratio of the light beam generated from the light source. The optical apparatus extracts a reproduction beam with an increased aspect ratio and emits the reproduction beam onto the display screen.

Consequently, the present invention can brightly illuminate the display screen because of the use of the optical element having the excellent diffraction efficiency. Owing to the excellent diffraction efficiency of the optical element, the number of apparatus parts can be decreased, making it possible to provide a simple, compact configuration of the optical apparatus.

### BRIEF DESCRIPTION OF THE SEVERAL VIEWS OF THE DRAWING

FIG. 1 is an example of an optical element according to the present invention, showing that a light beam enters an optical element comprising a reflective volume hologram is diffracted according to the volume hologram's diffraction characteristic, and is subject to aspect ratio conversion for outgoing;

FIG. 2 is a characteristic chart showing relationship among an incident angle θ₁, an outgoing angle θ₂, and an, aspect ratio conversion ratio;

FIG. 3 is a characteristic chart showing relationship between the outgoing angle θ₂ and a reduction rate 1/M;

FIG. 4 shows diffraction caused by a conventional diffraction grid;

FIG. 5 is a characteristic chart showing relationship between a depth from an optical element's incident surface, namely a thickness direction from an optical element's incident surface and a light beam energy at that depth (thickness);

FIG. 6 shows that an incident beam is diffracted at a large angle in an optical apparatus and the diffracted beam causes total reflection in the optical element;

FIG. 7 shows that a transparent substrate having a refractive index almost the same as that of an optical element is bonded to an incident and outgoing principal plane of the optical element and an incident light beam is applied to extract a diffracted beam;

FIG. 8 shows that a transparent substrate having a refractive index almost the same as that of an optical element comprising a reflective volume hologram is bonded to an incident and outgoing principal plane of the optical element and an incident light beam is applied to extract a diffracted beam;

FIG. 9 shows that a transparent substrate having a refractive index almost the same as that of an optical element comprising a transparent volume hologram is bonded to an incident and outgoing principal plane of the optical element and an incident light beam is applied to extract a diffracted beam;

FIG. 10 is a schematic configuration diagram of a liquid crystal display which uses an optical element comprising a reflective volume hologram provided with a refractive index matching prism and places a diffuser panel on an outgoing principal plane of the refractive index matching prism;

FIG. 11 is a schematic configuration diagram of a liquid crystal display which uses an optical element comprising a reflective volume hologram provided with a refractive index matching prism and forms a diffusion structure comprising fine protrusions on an outgoing principal plane of the refractive index matching prism;

FIG. 12 is a schematic configuration diagram of a liquid crystal display which uses an optical element comprising a transparent volume hologram provided with a refractive index matching prism and places a diffuser panel on an outgoing principal plane of the refractive index matching prism; and

FIG. 13 is a schematic configuration diagram of a liquid crystal display which uses an optical element comprising a transparent volume hologram provided with a refractive index matching prism and forms a diffusion structure comprising fine protrusions on an outgoing principal plane of the refractive index matching prism.

### DETAILED DESCRIPTION OF THE INVENTION

Embodiments of the present invention will be described in further detail with reference to the accompanying drawings.

An optical element according to the present invention comprises a volume hologram and converts an incident beam's aspect ratio to generate an outgoing beam.

Compared to ordinary grating or planar hologram, the volume hologram provides excellent characteristics including improved diffraction efficiency and wave length resolution. On the other hand, materials for the volume hologram are unstable and cause problems such as thermal expansion, stability under a humid condition, and the like. This has been a hindrance to practical use of the volume hologram. In recent years, however, the material development has advanced, making it possible to provide materials capable of practical use. Some materials show a refractive index change of around 10⁻².

The present invention uses a diffraction characteristic of this volume hologram.

Described below are embodiments of the present invention.

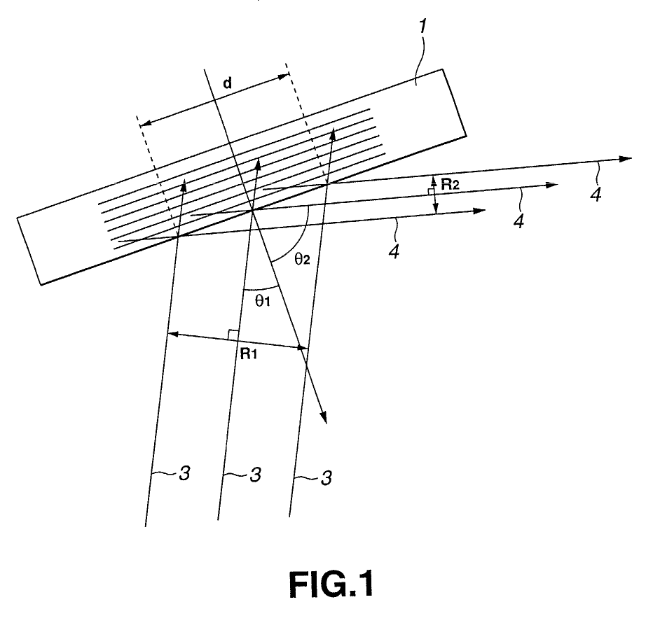

FIG. 1 shows an example of an optical element 1 to which the present invention is applied. A light beam enters the optical element 1 comprising a reflective volume hologram. The incident beam is diffracted according to a volume hologram's diffraction characteristic and is issued as an outgoing beam with the aspect ratio converted. The principle is described below with reference to FIG. 1.

In the figure, a first light beam 3 has an incident angle θ₁ and a beam diameter R₁ and enters an optical element 1 comprising a reflective volume hologram. When the first light beam 3 enters the optical element 1, the light beam 3's section diameter is assumed to be d. The optical element 1 diffracts a second light beam 4 and converts its aspect ratio. The thus processed second light beam 4 is generated with an outgoing angle θ₂ and a beam diameter R₂ in the figure. The relationship between θ₁ and R₁ and the relationship between θ₂ and R₂ are expressed as follows.

d cos θ₁=R₁ [Equation 1]

d cos θ₂=R₂ [Equation 2]

According to these equations, an aspect ratio conversion ratio M for the optical element 1 is expressed as follows.

M=R₂/R₁=cos θ₂/cos θ₁ [Equation 3]

The diameter is unchanged in a direction perpendicular to the figure.

According to the above-mentioned relationships, it is possible to obtain a beam whose diameter is enlarged or reduced with a specified magnification M in a given direction by properly selecting directions of two beams when the volume hologram is recorded.

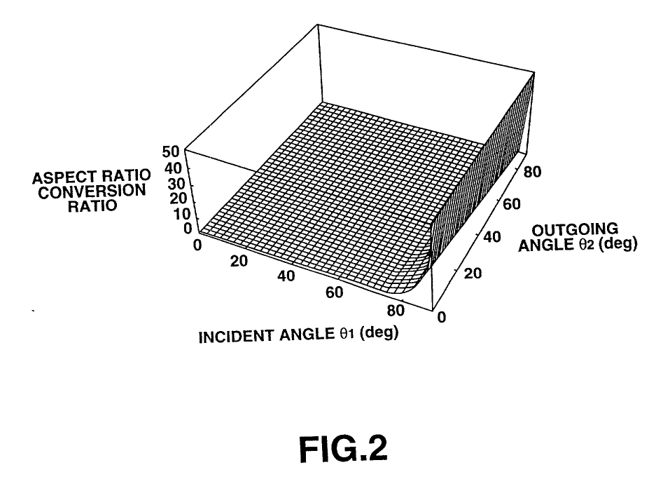

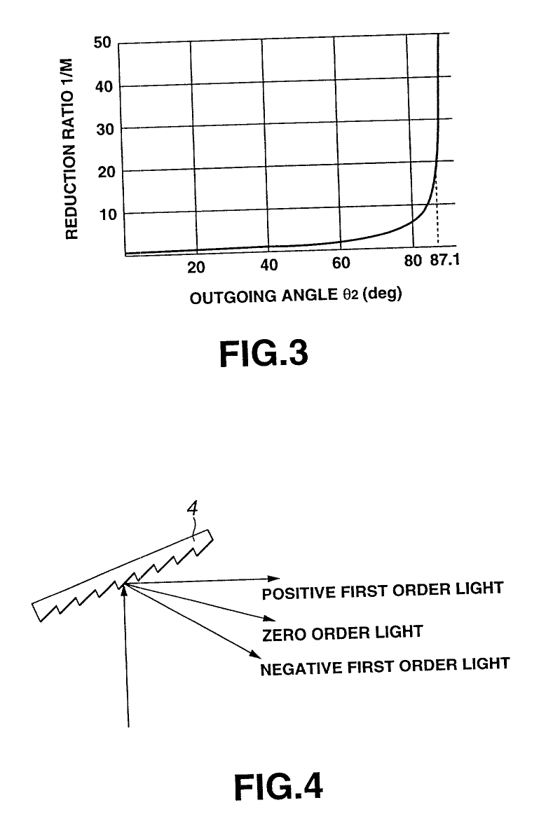

FIG. 2 shows a computation result using the magnification M as a function of θ₁ and θ₂ in the above description. FIG. 2 is a characteristic chart showing relationship among the incident angle θ₁, the outgoing angle θ₂, and the aspect ratio conversion ratio. According to FIG. 2, it is understood that a beam can be enlarged with a large magnification by reflecting an incident beam almost on the surface of the optical element 1 and generating an outgoing beam perpendicularly. By contrast, a beam can be reduced with a large magnification by switching an incident beam and an outgoing beam. When reducing a beam, it is desirable to configure the setting so that the incident beam enters at a right angle. FIG. 3 shows a computation result using the reduction rate 1/M as a function of θ₂ in the above description. FIG. 3 is a characteristic chart showing relationship between the outgoing angle θ₂ and the reduction rate 1/M. According to this figure, setting θ₂ to 87.1 degrees yields 1/M=20, for example. When this optical element 1 is used to convert the aspect ratio twice, a round parallel laser beam can be converted to a parallel beam with the aspect ratio of 400:1. This is a sufficiently high aspect ratio for directly illuminating, say, a grating light valve (hereafter referred to as GLV). For example, four pairs of anamorphic prisms (eight prisms in total) with 4-times magnification just provide an aspect ratio's conversion ratio with 256-times magnification. Considering this, it is well understood that the optical element using the volume hologram has an excellent conversion characteristic for the aspect ratio.

It is possible to convert the aspect ratio by using, say, a conventional diffraction grid 4 as shown in FIG. 4 or a phase-based or amplitude-based planar hologram. In such a case, the diffraction efficiency degrades, causing a disadvantageous effect on practical use. Especially, generation of an unnecessary higher order beam may be fatal to some uses. Generally, the use of a blazed-type diffraction grid makes it possible to provide high diffraction efficiency. When an attempt is made to reflect a beam at an acute angle as mentioned above, however, adjacent grids obstruct a diffraction beam. In this case, a spatial frequency for the diffraction grid increases, making it difficult to fabricate a highly efficient diffraction grid. The optical element according to the present invention is free from the above-mentioned problems and is capable of generating a reproduction beam with an enlarged or reduced aspect ratio with a desired magnification.

The conventional grating provides 70% to 80% diffraction efficiency at best. On the other hand, the optical element according to the present invention can provide approximately 98% diffraction efficiency, making it possible to generate a sufficient amount of reproduction beam.

Consequently, the use of the optical element according to the present invention easily enables conversion at a high beam aspect ratio which is conventionally possible only through the use of a plurality of anamorphic prisms. When an anamorphic prism is used, a single optical element according to the present invention can substitute for the complicated optical system. When configuring an optical apparatus, for example, the number of parts to be used can be decreased, simplifying the apparatus structure and making the apparatus compact.

Since the optical element according to the present invention has high diffraction efficiency, it is possible to decrease the amount of incident beam more effectively than the prior art. When configuring an optical apparatus, for example, it is possible to decrease loads on a light source and reduce the power consumption.

However, the optical element according to the present invention has some problems. First, diffraction occurs in a volume hologram storage medium. When the volume hologram has a large effective thickness, there occurs displacement between a reproduction beam diffracted on the optical element's incident surface and a reproduction beam diffracted within the optical element. When reducing a beam, it is necessary to consider beam diffusion due to this displacement. Here, the effective thickness of the volume hologram refers to a thickness which is sufficient for diffracting most part of the incident beam in the reflective volume hologram and transferring the incident beam's energy to the reproduction beam.

To suppress this effect, it is desirable to minimize the optical element thickness. The diffraction efficiency is the product of the optical material thickness multiplied by the refractive index fluctuation Δn. For providing sufficiently high diffraction efficiency, a volume hologram recording material needs to have a large refractive index fluctuation. Materials satisfying this condition include azo dyestuff doped photopolymer, cationic ring-opening polymerization (CROP) photopolymer, photopolymer with diffusion amplification (PDA photopolymer), and the like.

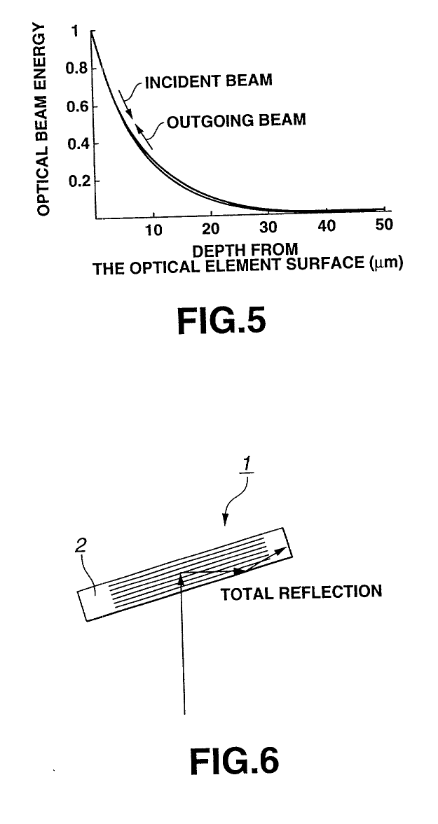

Such a material is used to configure the optical element comprising a reflective volume hologram having typical values of a refractive index n=1.492, a refractive index fluctuation Δn=0.01, and an effective wavelength λ=0.514 μm. FIG. 5 shows relationship between a depth from an optical element's incident surface, namely a thickness direction from an optical element's incident surface and a light beam energy at that depth (thickness). The ordinate axis represents an incident beam energy 1. As shown in FIG. 5, the light beam energy almost reaches 0 at a position 50 μm thick from the incident surface of the optical element. It is understood that approximately 50 μm is sufficient for the effective thickness of the optical element. This value is considered to be sufficiently small compared to a beam diameter for normal use. It is further understood that the use of these materials allows beams to be converted with a sufficiently large aspect ratio and solves the above-mentioned problems.

When the incident beam is diffracted at a large angle as shown in FIG. 6, there is a possibility that the diffracted beam will cause total reflection in the optical element 1 medium. In the above example, the total reflection against air forms a critical angle of 42 degrees. When the incident beam is reflected totally, the light beam direction changes. The aspect ratio conversion gives no effect on a light beam generated from the rear side, namely the principal plane opposite to the incident side of the optical element.

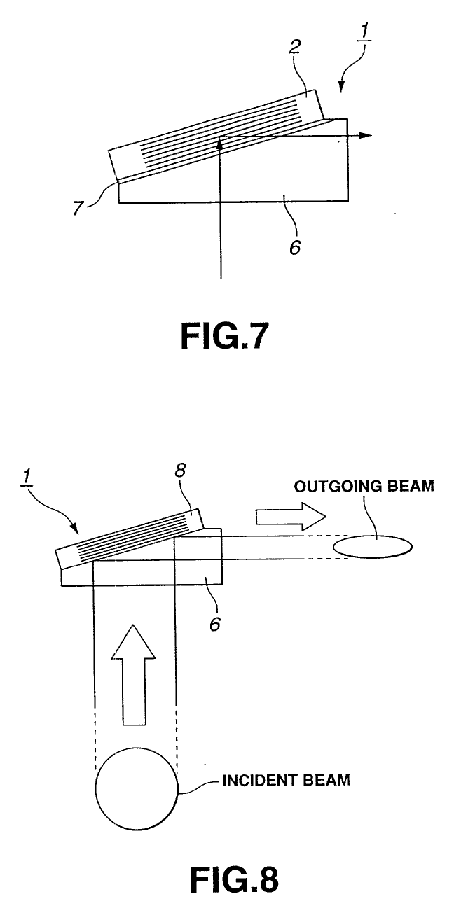

To solve this problem, a refractive index matching prism is used. For example, a wedge is formed on a member having a refractive index approximate to that of the optical element. This member is then attached to the optical element's outgoing principal plane by optical contact or bonding. FIG. 7 shows an example. In this figure, the optical element comprises a reflective volume hologram 8. A refractive index matching prism 6 is bonded to an incident and outgoing principal plane of the optical element using an adhesive 7 having almost the same refractive index as that of the optical element. The refractive index matching prism 6 comprises a transparent substrate having almost the same refractive index as that of the optical element. An incident light beam is applied to extract a diffracted beam. Even if the incident beam is diffracted at a large angle, this configuration prevents a diffracted beam against total reflection in the optical element 1 medium. This makes it possible to extract the diffracted beam in good condition.

When the above-mentioned member is bonded to the optical element 1, it is desirable to maintain conformity between the refractive index of the adhesive 7 and that of the optical element 1.

It may be preferable to apply coating on the incident and outgoing faces of the refractive index matching prism 6 for a light beam or use a Brewster angle. This treatment further improves extraction of a diffracted beam.

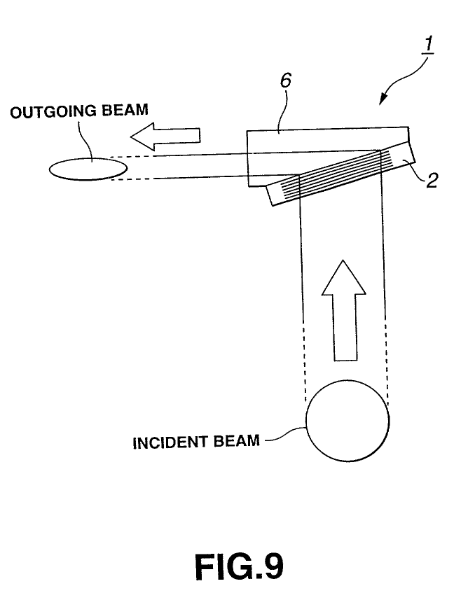

In the example described above, the optical element 1 uses the reflective volume hologram 8. It may be preferable to use a transparent volume hologram 9. Whichever type of the volume hologram is used, it is a good practice to place the refractive index matching prism 6 on the outgoing beam side as shown in FIGS. 8 and 9.

The above example mainly relates to the optical element using the reflective hologram. Obviously, the transparent hologram can be used likewise. It should be noted that the reflective hologram makes fabrication easier. Since the principle is reciprocal, the aspect ratio can be enlarged or reduced by applying a light beam from the opposite side in a reverse direction. For example, the optical element comprises a volume hologram capable of aspect ratio enlargement with M-times magnification. It is possible to provide aspect ratio reduction with M-times magnification by replacing the incident beam with the diffracted beam and vice versa in a reverse direction.

Various applications are available with the aspect ratio conversion using this optical element. Examples include converting an aspect ratio for the semiconductor laser, converting a beam shape in conformity with an acoustooptic element aperture, and the like in whichever case an anamorphic prism is used.

The use of this optical element is especially effective for an illuminating optical system using a spatial modulator. For example, this optical element can be used for a one-dimensional spatial modulator with a high aspect ratio such as the GLV. In this case, a highly efficient optical system can be designed easily by generating and irradiating a flat and parallel beam with this optical element.

In recent years, a liquid crystal display's back panel has been diversely researched and developed. Since the conventional light guide plate is based on reflection, a beam slantwise enters the liquid crystal panel. To solve this problem, a prism sheet is needed, for example. However, the optical element according to the present invention allows a beam to enter the liquid crystal panel perpendicularly.

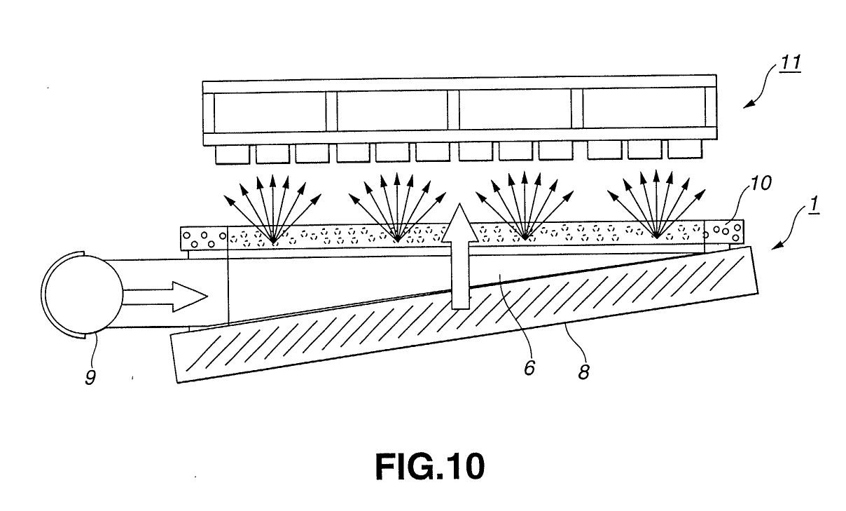

FIGS. 10 to 13 show examples of configuring a liquid crystal display using this optical element. FIG. 10 is an example of using the optical element 1 comprising the reflective volume hologram 8 provided with the refractive index matching prism 6 and placing a diffuser panel 11 on an outgoing principal plane of the refractive index matching prism 6. In this case, a light beam is irradiated from a reflector-equipped lamp 10 and enters the optical element 1. After the aspect ratio is converted, the beam is emitted as a diffracted beam via the refractive index matching prism 6. After emitted from the refractive index matching prism 6, the diffracted beam is diffused by a diffuser panel 11 and is irradiated to a liquid crystal panel 12. Consequently, this configuration enables conversion of a high aspect ratio for the light beam generated from the reflector-equipped lamp 10. Further, the light beam can enter the liquid crystal panel 12 perpendicularly, improving the visual field characteristic.

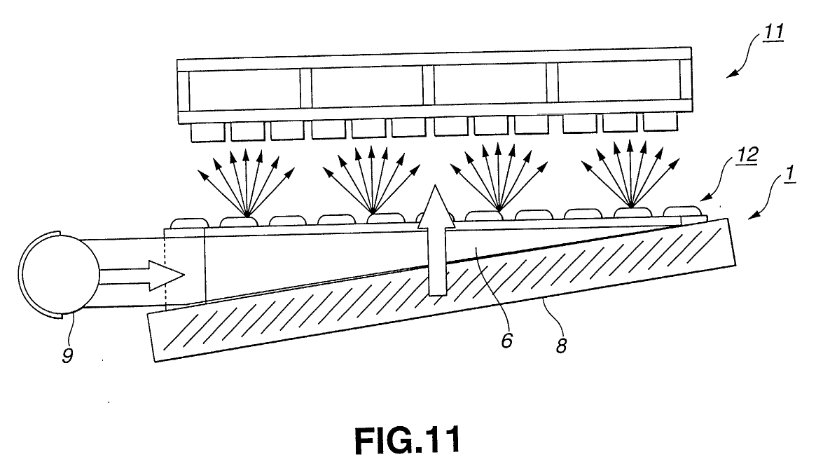

FIG. 11 is an example of using an optical element comprising the reflective volume hologram 8 provided with the refractive index matching prism 6 and forming a diffusion structure 13 comprising fine protrusions on the outgoing principal plane of the refractive index matching prism 6. In this case, a light beam is irradiated from a reflector-equipped lamp 10 and enters the optical element 1. After the aspect ratio is converted, the beam is emitted as a diffracted beam via the refractive index matching prism 6. After emitted from the refractive index matching prism 6, the diffracted beam is diffused by the diffusion structure 13 comprising fine protrusions and is irradiated to the liquid crystal panel 12. Like FIG. 10, this configuration enables conversion of a high aspect ratio for the light beam generated from the reflector-equipped lamp 10. Further, the light beam can enter the liquid crystal panel 12 perpendicularly, improving the visual field characteristic.

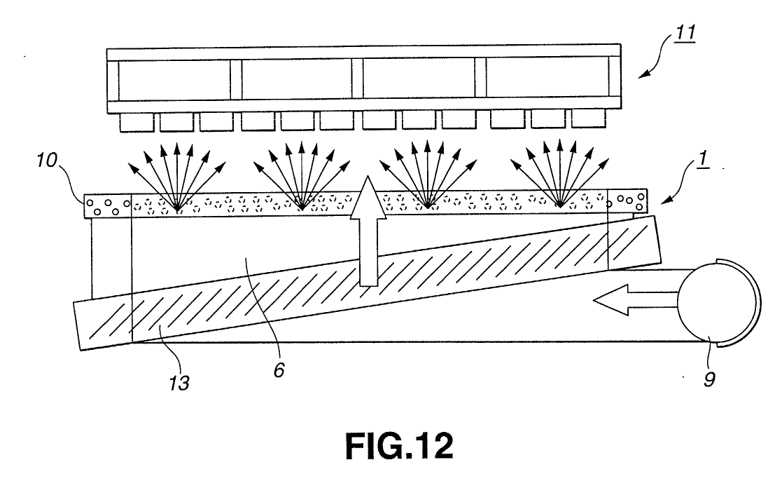

FIG. 12 is an example of using the optical element 1 comprising the transparent volume hologram 9 provided with the refractive index matching prism 6 and placing the diffuser panel 11 on an outgoing principal plane of the refractive index matching prism 6.

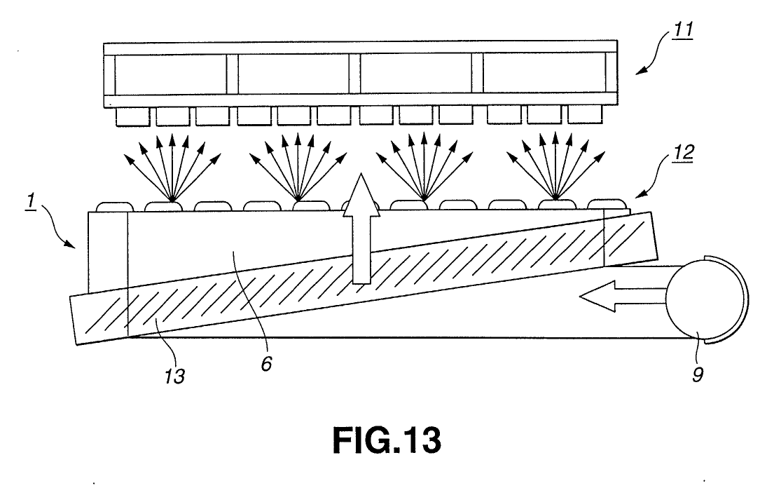

FIG. 13 is an example of using the optical element 1 comprising the transparent volume hologram 9 provided with the refractive index matching prism 6 and forming the diffusion structure 13 comprising fine protrusions on an outgoing principal plane of the refractive index matching prism 6.

FIGS. 12 and 13 provides effects similar to those described for FIGS. 10 and 11.

Accordingly, it is possible to farther improve the visual field characteristic by using the optical element according to the present invention together with techniques of diffusion, fine protrusions, and the like.

The optical element according to the present invention allows considerably higher aspect ratio conversion than the conventional beam diameter conversion using an anamorphic prism and the like. It is possible to more effectively perform aspect ratio conversions using an anamorphic prism and the like such as converting an aspect ratio for the semiconductor laser and converting a beam shape in conformity with an acoustooptic element aperture.

The use of the optical element according to the present invention for an optical apparatus such as a liquid crystal display can effectively improve the visual field characteristic. Further, the number of parts can be decreased, making the apparatus configuration simple and compact. The apparatus is available cost-effectively and improves reliability. Since the optical utilization efficiency improves, it is possible to decrease loads on a light source and reduce the power consumption.

What is claimed is:

1. An optical element comprising a volume hologram for emitting an outgoing beam by converting an aspect ratio of an incident beam.

2. The optical element according to claim 1, wherein said volume hologram is a transparent volume hologram.

3. The optical element according to claim 1, wherein said volume hologram is a reflective volume hologram.

4. The optical element according to claim 1, wherein a prism is arranged on an outgoing side of said volume hologram and said outgoing beam with the converted aspect ratio is prevented from being totally reflected on an outgoing face of said volume hologram.

5. An optical apparatus comprising a light source for generating a light beam with a specified aspect ratio, an optical element comprising a volume hologram, and a display screen illuminated by a beam emitted from said light source, wherein
said optical element converts an aspect ratio of an incident beam generated from said light source and irradiated to said optical element, emits a reproduction beam, and illuminates said display screen using said reproduction beam with the converted aspect ratio.

6. The optical apparatus according to claim 5, wherein said volume hologram is a transparent volume hologram.

7. The optical apparatus according to claim 5, wherein said volume hologram is a reflective volume hologram.

8. The optical apparatus according to claim 5, wherein a prism is arranged on an outgoing side of said optical element and said outgoing beam with the converted aspect ratio is prevented from being totally reflected on an outgoing face of said optical element.
